(19) United States
(12) Patent Application Publication
(10) Pub. No.: US 2006/0179465 A1
(43) Pub. Date: Aug. 10, 2006

(54) Handling feature availability in a broadcast

(75) Inventor: Johannes Hendrikus Maria Lemmers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONCS N.V., EINDHOVEN (NL)

(21) Appl. No.: 10/565,816

(22) PCT Filed: Jul. 14, 2004
(86) PCT No.: PCT/IB04/51224

§ 371 Date: Jan. 24, 2006

(30) Foreign Application Priority Data
Jul. 24, 2003 (EP) 03102283.3

(51) Int. Cl. H04N 7/173

(52) U.S. Cl. 725/100; 725/131

(57) ABSTRACT

The present invention relates to a method, for a receiver adapted for receiving broadcasted signal from a broadcaster, of handling the execution of a first independent feature, where at least a part of the feature data needed to execute said first independent feature is comprised in said broadcaster signal together with feature data needed to execute at least a second independent feature, and wherein said feature data are broadcasted as ata carousels, the method comprising the steps of: receiving instructions identifying said first feature, wherein the instructions further comprise an identification that the identified first feature is to be executed, loading, from the data carousel, the feature data related to said first feature, into memory of said receiver, executing said identified feature. By only activating specific features and loading feature data when the feature is to be executed, the broadcaster can add/remove/replace applications during broadcast, by removing carousels not being used and introducing new carousels. E.g. by placing all the applications in one xlet, all the functionalities provided by the xlet are active. So for example a network portal is always one key away.

The present invention relates to a method, for a receiver adapted for receiving broadcasted signal from a broadcaster, of handling the execution of a first independent feature. The invention also relates to a method, for a broadcaster adapted to transmit a broadcast signal, of broadcasting a first independent feature to be executed by a receiver. The invention also relates to a receiver adapted for receiving broadcasted signal from a broadcaster, where the receiver is adapted for handling the execution of a first independent feature. The invention also relates to a broadcaster adapted to transmit a broadcast signal, adapted for broadcasting a first independent feature to be executed by a receiver. Further, the invention relates to a broadcast signal for broadcasting a first independent feature to be executed by a receiver.

The Multimedia Home Platform (MHP) defines a generic interface between interactive digital features and the terminals on which those features execute. This interface decouples different provider's features from the specific hardware and software details of different MHP terminal implementations. It enables digital content providers to address all types of terminals ranging from low-end to high-end set top boxes, integrated digital TV sets and multimedia PCs. The MHP extends the existing, successful DVB open standards for broadcast and interactive services in all transmission networks including satellite, cable, terrestrial and microwave systems.

A MHP feature consists of one or more files placed in a directory structure. These files contain code, data and/or images. Such file system is placed in one (or multiple) DSMCC carousel.

A full description of the DSM-CC specification may be found in ISO/IEC 13818-6. It enables a broadcaster to broadcast a “virtual file system” on top of MPEG-2 private sections. Receivers can then navigate and retrieve data from this virtual file system. The specification provides protocols for downloading software components from servers to clients. In particular, the DSM-CC system is applicable to DVB (Digital Video Broadcasting) systems, which provide interactive multi-media features such as video on demand (VOD), near video on demand (NVOD), home shopping, news on demand and electronic program guides (EPG).

Two philosophies for downloading the data needed to implement these features can be identified. The first, bidirectional downloading, occurs when the client sets up download control parameters with the server and then requests the software module to be downloaded. The actual data is then conveyed from the server to the client as a series of messages. This philosophy requires two-way communication so that the client can request particular software modules. The second philosophy, unidirectional downloading, is applicable to systems, in which only one-way communication is available (for example in digital video broadcasting). In the case of such broadcasting, there is not necessarily any mechanism for the client to send messages to the server. However, it is still possible to download data from the server to clients by repeatedly sending download control messages followed by download data messages over the broadcast channel. These control and data messages are cyclically transmitted over time, and the client can choose whether to ignore them or receive and process them. The client cannot control when the various messages are sent. This system of the broadcast of cyclically repeating various modules is called a Data Carousel system.

The Data Carousel can be described as a transport mechanism that allows a server to present a set of distinct data modules to a decoder at the client by cyclically repeating the contents of the Carousel, one or more times. A well known example of the Data Carousel concept is the Teletext system, in which a complete set of teletext pages is cyclically broadcasted in some lines of an analogue video signal that are not part of the active picture. When users request a page, they must usually wait for the next time the page is broadcasted.

Within a Data Carousel, the data is structured into modules, and the modules could contain the contents of a file. Where a first module relates to “file1”, a second module relates to “file2”, and a third module relates to “file3”. Each module is divided to form a payload of one or more download data messages each defined using the DSM-CC DownloadDataBlock syntax. The number of such download data messages depends on the size of the module and the maximum payload of each download data message. Information describing each module and any logical grouping is provided by download control messages, defined using either the DSM-CC DownloadServerInitiate or DownloadInfoIndication syntaxes as appropriate.

In general, there are no restrictions on how often a particular message is inserted into the Carousel and the order and relative position of messages. This allows the Data Carousel to be created in a way that suits a particular use the best.

An additional protocol on top of the Data Carousel (xlet level) known as an Object Carousel may be used to provide a virtual file system at the client. When an Object Carousel is used, actual DSM-CC objects (such as files and directories) can be conveyed to the client inside the modules that the Data Carousel extracts from the download data messages. Using the Object Carousel makes it possible to provide clients that have limited, or no, local storage (for example a set top box) with a virtual file system, in which it can access DSM-CC objects as if they were local.

A DSM-CC Object Carousel facilitates the transmission of a structured group of objects from a broadcast server to broadcast receivers (clients) using directory objects, file objects and stream objects. The actual directory and content (object implementations) are located at the server. The server repeatedly inserts the mentioned objects in a DVB compliant MPEG-2 transport stream using the Object Carousel protocol.

The directory and file objects contain the data needed to reconstruct the directory and files at the server, while the transmitted stream objects are references to other streams in the broadcast. The stream objects may also contain information about the DSM-CC events that are broadcasted within a particular stream. DSM-CC events can be broadcasted with regular stream data and can be used to trigger DSM-CC features.

Clients can recover the object implementations by reading the repeatedly transmitted Carousel data, and hence mimicking the server's objects in a local object implementation. It can be seen that the Object Carousel provides a way for clients to access features and the content used by these features, even though there is not an interactive connection with the server.

According to the DSM-CC Data Carousel specification each module is fragmented into one or more blocks, which are carried in a DownloadDataBlock message. Each DownloadDataBlock message is of the same size (except for the last block of the module, which may be of a smaller size) and is transmitted in turn in an MPEG-2 private section. The encapsulation rules for DownloadDataBlock messages and MPEG-2 private sections are such that blocks can be acquired directly from the transport stream using hardware filters found generally on demultiplexers.

When a broadcaster wants to broadcast multiple features he may decide to put each independent feature in a single xlet. However, when he wants multiple features to be active at the same time, the MP middleware feature must support simultaneous activation of multiple features.

It is an object of the present invention to provide a method of solving the above problem and make it possible to activate multiple features on standard MHP middleware not specifically supporting this.

This is obtained by a method, for a receiver adapted for receiving broadcasted signal from a broadcaster, of handling the execution of a first independent feature, where at least a part of the feature data needed to execute said first independent feature is comprised in said broadcaster signal together with feature data needed to execute at least a second independent feature, and wherein said feature data are broadcasted as data carousels, the method comprising the steps of:
receiving instructions identifying said first feature, wherein the instructions further comprise an identification that the identified first feature is to be executed,
loading, from the data carousel, the feature data related to said first feature, into memory of said receiver,
executing said identified feature.

By only activating specific features and loading feature data when the feature is to be executed, the broadcaster can add/remove/replace applications during broadcast, by removing carousels not being used and introducing new carousels. By placing all the applications in one xlet, all the functionalities provided by the xlet are active. So for example the network portal is always one key away.

In a specific embodiment the step of loading, from the data carousel, the feature data related to said first feature, into memory of said receiver comprises the step of:
mounting the data carousel comprising the feature data needed to execute said first independent feature,
creating a class loader being dedicated to said first feature.

In the case of java class files, the feature specific class loader ensures that the feature can be removed together with all feature specific data without influencing other features. This ensures that an optimized amount of memory resources can be released when a feature is stopped, by only removing all the references to a feature specific class loader.

In a specific embodiment the method further comprises the steps of:
receiving instructions identifying a feature, wherein the instructions further comprise an identification that the identified feature is to be terminated,
terminating said feature,
removing the feature data, related to said identified feature, from memory of said receiver.

By removing a feature from memory after usage it is ensured that the receiver does not run out of memory. Besides freeing the memory resources used by a feature being terminated, other resources such as a tuner modem or graphics device could also be released.

In an embodiment the step of removing the feature data, related to said identified feature, from memory of said receiver comprises the steps of:
unmounting the data carousel comprising the feature data needed to execute said first independent feature and removing it from the memory,
removing all the references to the class loader being dedicated to said first feature and removing it from the memory.

In the case of java class files, which use feature specific class loaders, the features could be further cleaned up by removing these class loaders from the receiver memory.

In another embodiment the instructions identifying said first independent feature are received from the broadcaster. Thereby the broadcaster can control the features such as e.g. controlling the lifecycle of features running on the receiver by activating or terminating features on the receiver.

In another embodiment the instructions identifying said first independent feature are received from a user communicating with the receiver. Thereby the user can control the features on the receiver, such as e.g. activate or terminate features on the receiver.

In an embodiment the receiver presents an identification of at least a part of said broadcast independent features to said user, and the instructions identifying said first independent feature are based on said presentation.

The identification of the broadcast features is present in the broadcast feature table, and by using the information in the feature table the receiver can easily present the available features on a user interface. The user can then use this presentation to select a feature, and it is ensured that the user can only select between available features. Further, user instructions could be start/activate, stop/terminate/deactivate, hide/iconise/minimise or show/de-iconise/maximise.

The invention further relates to a method, for a broadcaster adapted to transmit a broadcast signal, of broadcasting a first independent feature to be executed by a receiver, where at least a part of the feature data needed to execute said first independent feature is comprised in said broadcaster signal together with feature data needed to execute at least a second independent feature, and wherein said feature data are broadcasted as data carousels, the method comprising the step of broadcasting feature data needed to execute a third independent feature, where said third independent feature enables the receiver to handle the execution of said first independent feature by:
receiving instructions identifying said first feature, wherein the instructions further comprise an identification that the identified first feature is to be executed,
loading, from the data carousel, the feature data related to said first feature, into memory of said receiver,
executing said identified feature.

The invention also relates to a receiver adapted for receiving broadcast signal from a broadcaster, where the receiver is adapted for handling the execution of a first independent feature, where at least a part of the feature data needed to execute said first independent feature is comprised in said broadcaster signal together with feature data needed to execute at least a second independent feature, and wherein said feature data are broadcasted as data carousels, the receiver comprising:
means for receiving instructions identifying said first feature, wherein the instructions further comprise an identification that the identified first feature is to be executed,
means for loading, from the data carousel, the feature data related to said first feature, into memory of said receiver,
means for executing said identified feature.

The invention also relates to a broadcaster adapted to transmit a broadcast signal, adapted for broadcasting a first independent feature to be executed by a receiver, where at least a part of the feature data needed to execute said first independent feature is comprised in said broadcaster signal together with feature data needed to execute at least a second independent feature, and wherein said feature data are broadcasted as data carousels, the broadcaster comprises means for broadcasting feature data needed to execute a third independent feature, where said third independent feature enables the receiver to handle the execution of said first independent feature by:
receiving instructions identifying said first feature, wherein the instructions further comprise an identification that the identified first feature is to be executed,
loading, from the data carousel, the feature data related to said first feature, into memory of said receiver,
executing said identified feature.

Further, the invention also relates to a broadcast signal for broadcasting a first independent feature to be executed by a receiver, where at least a part of the feature data needed to execute said first independent feature is comprised in said broadcaster signal together with feature data needed to execute at least a second independent feature, and wherein said feature data are broadcasted as data carousels, the broadcaster signal further comprises feature data needed to execute a third independent feature, where said third independent feature enables the receiver to handle the execution of said first independent feature by:
receiving instructions identifying said first feature, wherein the instructions further comprise an identification that the identified first feature is to be executed,
loading, from the data carousel, the feature data related to said first feature, into memory of said receiver,
executing said identified feature.

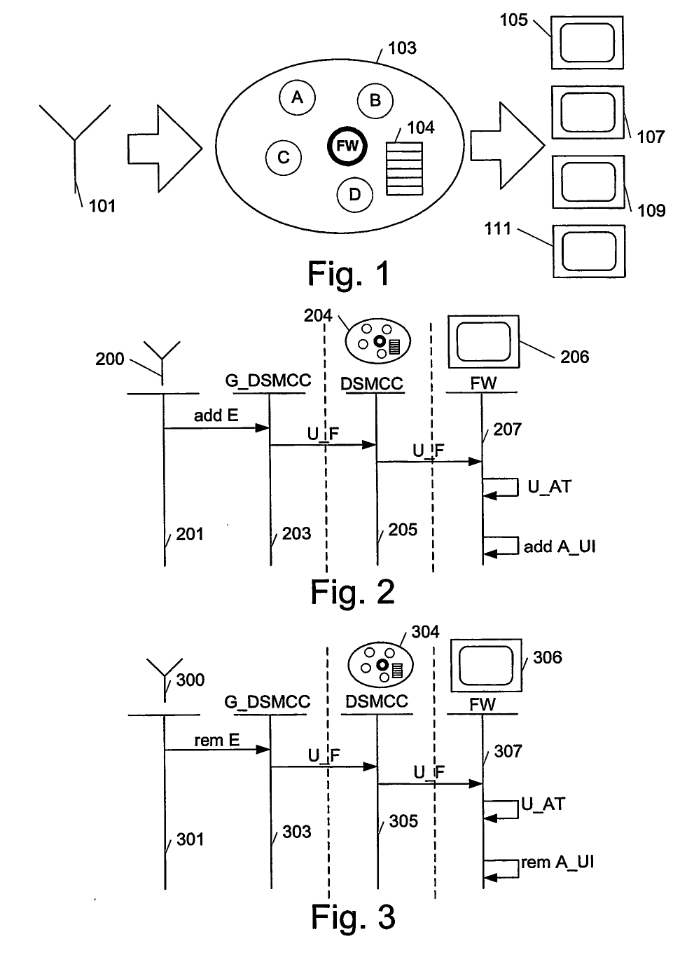

In the following preferred embodiments of the invention will be described referring to the figures, where FIG. 1 shows a broadcast system comprising a broadcaster broadcasting a broadcast signal and a number of receivers adapted to receive the broadcast signal;

FIG. 2 shows the steps of making a new feature available to the user of a receiver when the broadcaster starts broadcasting an additional feature;

FIG. 3 shows the steps of removing the availability of a feature to the user of a receiver when the broadcaster stops broadcasting a feature;

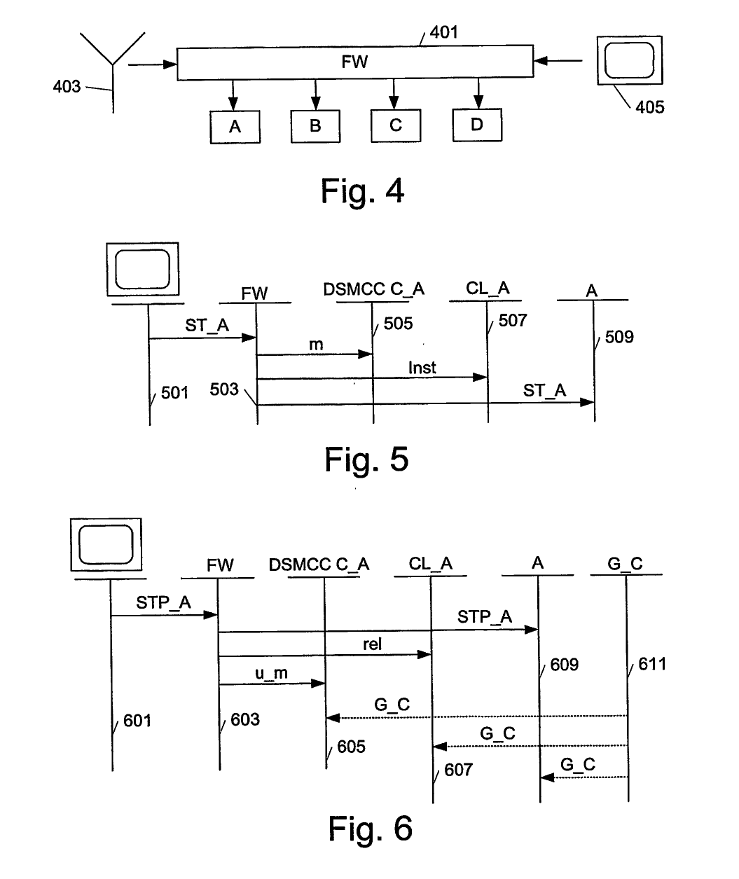

FIG. 4 illustrates the structure if the framework feature and other features;

FIG. 5 shows the steps of executing a feature on a receiver, when the user of the receiver starts the feature;

FIG. 6 shows the steps of terminating a feature on a receiver, when the user of the receiver stops the feature;

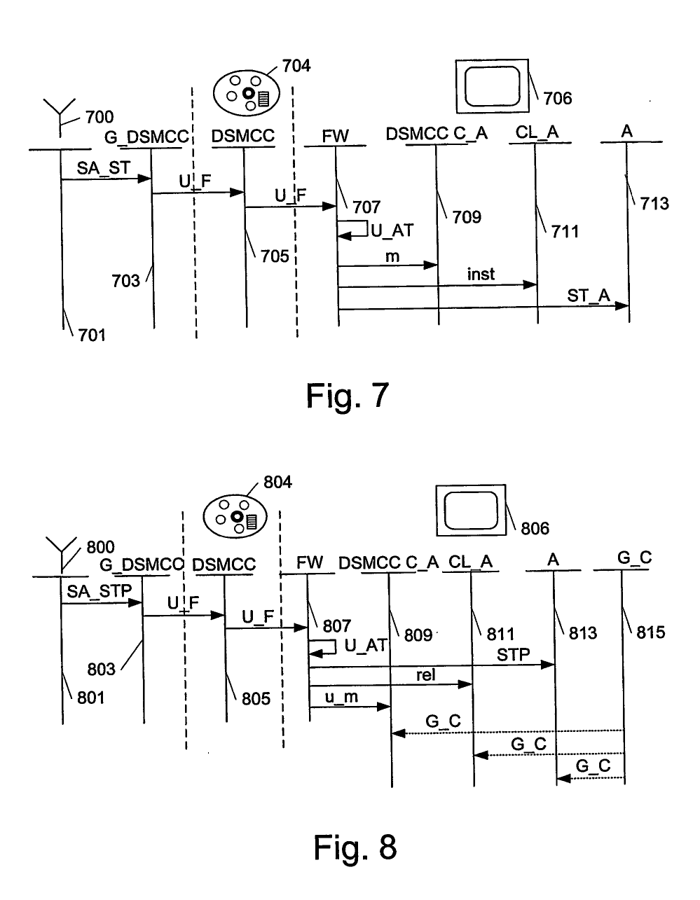

FIG. 7 shows the steps of executing a broadcasted feature on a receiver, when the broadcaster starts the feature;

FIG. 8 shows the steps of terminating a feature on a receiver, when the broadcaster stops the feature.

In FIG. 1 a broadcast system is illustrated comprising a broadcaster 101 broadcasting a broadcast signal 103 and a number of receivers 105, 107, 109, 111 adapted to receive the broadcast signal 103. The broadcast signal 103 comprises an application combining a number of independent features A, B, C, D and FW, and these features are transmitted as a single xlet, where the Framework feature (FW) then manages the navigation between the different features, the other features A, B, C and D could be features such as a TV guide, a program notifier, a quiz and a clock. In a specific embodiment the framework functionality could be spread over the features A, B, C and D.

The broadcaster 101 has to provide information to the frame work feature about the features, which are presently broadcasted and the present status. This information might be provided in a feature table 104. Such table shall contain at least the following fields:
Feature name—to be shown to the user of the receiver 105.
Carousel identification—which is the address of the carousel containing the xlet, as specified in MHP specification.
Startup class name—which is the initial class to start execution of this feature.
Feature status—to be used by the broadcaster 101 to control the lifecycle of the feature and if no broadcaster control is needed then this field is not necessary.

This information enables the framework to present features to the user of the receiver, to start/stop features on command of the user and to start/stop/add/remove features on command of the broadcaster.

When being transmitted as separate features managed by the framework feature, each feature has its own file structure. For example the mentioned clock feature could consist of the following files:

com\philips\xlets\clock\ClockXlet.class
com\philips\xlets\clock\ClockHand.class
com\philips\xlets\clock\bankground.gif.

When the Clock feature is broadcasted as an xlet the DSMCC carousel will have the following structure:

\com\philip\xlets\clock\ClockXlet.class
\com\philip\xlets\clock\ClockHand.class
\com\philip\xlets\clock\background.gif

When the features such as a TV guide, a program notifier, a quiz and a clock are combined in one single xlet, the xlet consists of multiple carousels. One carousel for each feature, and one additional carousel for the framework.

Framework feature
\com\philip\xlets\framework\FrameworkXlet.class
\com\philip\xlets\framework\AppsAdministration.dat
\com\philip\xlets\framework\<other framework classes and files>
Clock feature
\com\philip\xlets\clock\ClockXlet.class
\com\philip\xlets\clock\ClockHand.class
\com\philip\xlets\clock\background.gif
Quiz feature
\com\philip\xlets\quiz1\Quiz1Appl.class
\com\philip\xlets\quiz1\<other EPG classes and files>
Program guide feature
\com\philip\xlets\epg\EpgAppl.class
\com\philip\xlets\epg\<other EPG classes and files>
Notifier feature
\com\philip\xlets\notifier\NotifierAppl.class
\com\philip\xlets\notifier\<other Notifier classes and files>

The broadcaster may use one ‘Object Carousel with multiple data carousel, or he can use multiple object carousel.

When the user of the receiver 105 wants to use one of the features, the framework will create a dedicated class loader for this feature. Secondly, it will access the carousel and activate the feature. The framework will be responsible for screen and key management, but also the active features have access to screen and keys.

When the same feature is not required any more, the framework will deactivate and remove the feature. When the dedicated feature class loader is removed, all (feature related) classes will be removed from memory and the memory can be reused for other purposes. When the related DSMCC carousel is unmounted, also the DSMCC caches of the related carousel can be flushed.

When e.g. the Quiz1 feature must be replaced by Quiz2, the operator can remove the carousel with content Quiz1. The framework can stop the instances of Quiz1 and remove related data from memory. Quiz2 is placed in a new carousel. And the DSMCC carousel generator starts injecting the Quiz2 carousel. Thereby, the bandwidth and receiver resources of Quiz1 are re-used by Quiz2.

In FIG. 2 it is illustrated how a new feature E is made available to the user of a receiver 206 when the broadcaster 200 starts broadcasting an additional feature E. First in 201 the broadcaster gives information that the E feature should be added (add E) to the broadcasted signal 204, and the E feature is added (U_F) to the feature table in the broadcasted signal. Then in 203 the DSMCC generator starts broadcasting the broadcast signal 204 comprising the updated table. In 205 the new DSMCC carousel is broadcasted and in 207 the framework detects the update (U_F) and updates the locally stored feature table correspondingly (U_FT) and presents the new feature to the user by adding the feature to the user interface (add E_UI) presented to the user by the receiver 206.

In FIG. 3 it is illustrated how availability of a feature E is removed from the user of a receiver 306 when the broadcaster 300 stops broadcasting a feature. First in 301 the broadcaster gives information that the E feature should be removed (rem E) from the broadcasted signal 304, and the E feature is removed (U_F) from the feature table in the broadcasted signal 304. Then in 303 the DSMCC generator starts broadcasting the broadcast signal 304 comprising the updated table (U_Y). In 305 the new DSMCC carousel is broadcasted, and in 307 the framework detects the update (U_F) and updates the locally stored feature table correspondingly (U_FT) and presents an updated selection of features, where the E feature has been removed by removing the feature E from the user interface (rem E_UI) presented to the user by the receiver 306.

In FIG. 4 the structure of the framework feature together with the other features is illustrated. When the single xlet comprising the framework is received by the receiver, then the framework is executed, and the framework 401 then manages the execution and termination of the other features A, B, C and D. The execution and termination of features can either be based on commands received from the user of the receiver 405, or it can be based on commands received from the broadcaster 403.

In the following scenarios will be described where respectively the broadcaster and the user of the receiver execute and terminate features.

In FIG. 5 the steps of executing a feature on a receiver is illustrated, when the user of the receiver starts the feature. Initially the framework is presenting the available features to the user via a user interface on the receiver. In 501 based on the user interface, which presents available features according to the feature table, the user activates the feature A e.g. by using an input device connected to the receiver, such as a keyboard or a remote control. Next a command indicating to start feature A (ST_A) is sent to the framework. In 503 the framework feature receives the command, and the framework feature makes sure that the feature data related to feature A is loaded from the carousel into the memory of the receiver. The framework feature initiates this loading by first in 505 mounting (m) the carousel containing application A (DSMCC C_A), and in 507 the framework feature activates the creation of a dedicated class loader by instantiating the class loader relevant to A. Finally, in 509 the framework feature starts application A (ST_A).

In FIG. 6 the steps of terminating a feature on a receiver is illustrated, when the user of the receiver stops the feature. In 601, based on the user interface, which presents available features according to the feature table, the user terminates the feature A e.g. by using an input device connected to the receiver, such as a mouse or a remote control. Next, a command indicating to stop feature A (STP_A) is sent to the framework. In 603 the framework feature receives the command, and in 609 the framework feature stops feature A (STP_A). In 607 the framework feature deactivates the dedicated class loader by removing all the references to the class loader relevant to A. Next, in 605 the carousel containing application A (DSMCC C_A) is unmounted (u_m). Finally, the garbage collector 611 removes (G_C) the data used for respectively the carousel, the class loader and the feature from the memory of the receiver.

In FIG. 7 the steps of executing a broadcasted feature on a receiver 706 are illustrated, when the broadcaster 700 starts the feature on the receiver 706. First in 701 the broadcaster 700 gives information that the A feature should be started by setting the status of A to start (SA_ST) in the feature table to be broadcasted in the broadcasted signal. Then, in 703 the DSMCC generator (G_DSMCC) starts broadcasting the broadcast signal 704 comprising the updated table (U_F). In 705 the new DSMCC carousel is broadcasted, and in 707 the framework detects the update (U_F) and updates the locally stored feature table correspondingly (U_AT). The framework feature makes sure that the feature data related to feature A are loaded from the carousel into the memory of the receiver 706. The framework feature initiates this loading by first in 709 mounting (m) the carousel containing application A (DSMCC C_A), and in 711 the framework feature activates the creation of a dedicated class loader by instantiating the class loader relevant to A. Finally, in 713 the framework feature starts application A (ST_A).

In FIG. 8 the steps of terminating a feature on a receiver is illustrated, when the broadcaster 800 stops or terminates the feature. First in 801 the broadcaster 800 gives information that the A feature should be stopped by setting the status of A to stop (SA_STP) in the feature table to be broadcasted in the broadcasted signal 804. Then, in 803 the DSMCC generator (G_DSMCC) starts broadcasting the broadcast signal 804 comprising the updated table (U_F). In 805 the updated DSMCC carousel is broadcasted, and in 807 the framework detects the update (U_F) and updates the locally stored feature table correspondingly (U_AT). In 813 the framework feature stops feature A (STP_A). In 811 the framework feature deactivates the dedicated class loader by removing all the references to the class loader relevant to A. Next, in 809 the carousel containing application A (DSMCC C_A) is unmounted (u_m). Finally, the garbage collector 815 releases (G_C) the memory of the receiver 806, which was occupied by the data for respectively the carousel, the class loader and the feature.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method, for a receiver (105, 107, 109, 111) adapted for receiving broadcasted signal (103) from a broadcaster (101), of handling the execution of a first independent feature, where at least a part of feature data (A, B, C, D), needed to execute said first independent feature, is comprised in said broadcasted signal as data relating to a first Xlet, wherein said data relating to said first Xlet further comprise feature data needed to execute at least a second independent feature (A, B, C, D), and wherein said feature data are broadcasted as data carousels, the method comprising the steps of:
receiving instructions identifying said first feature, wherein the instructions further comprise an identification that the identified first feature is to be executed,
loading, from the data carousel, the feature data related to said first feature into memory of said receiver,
executing said identified feature.

2. A method according to claim 1, wherein the step of loading, from the data carousel, the feature data related to said first feature, into memory of said receiver comprises the step of:
mounting the data carousel comprising the feature data needed to execute said first independent feature,
creating a class loader being dedicated to said first feature.

3. A method according to claim 1, wherein the method further comprises the steps of:
receiving instructions identifying a feature, wherein the instructions further comprise an identification that the identified feature is to be terminated,
terminating said feature,
removing the feature data, related to said identified feature, from memory of said receiver.

4. A method according to claim 3, wherein the step of removing the feature data, related to said identified feature, from memory of said receiver comprises the steps of:
unmounting the data carousel comprising the feature data needed to execute said first independent feature and removing it from the memory,
removing all references to the class loader being dedicated to said first feature and removing it from the memory.

5. A method according to claim 1, wherein the instructions identifying said first independent feature is received from the broadcaster.

6. A method according to claim 1, wherein the instructions identifying said first independent feature is received from a user communicating with the receiver.

7. A method according to claim 6, wherein the receiver presents an identification of at least a part of said broadcasted independent features to said user and the instructions identifying said first independent feature is based on said presentation.

8. A method, for a broadcaster adapted to transmit a broadcast signal, of broadcasting a first independent feature to be executed by a receiver, where at least a part of the feature data needed to execute said first independent feature is comprised in said broadcaster signal as data relating to a first Xlet, wherein said data relating to said first Xlet further comprise feature data needed to execute at least a second independent feature, and wherein said feature data are broadcasted as data carousels, the method comprising the step of broadcasting feature data needed to execute a third independent feature, where said third independent feature enables the receiver to handle the execution of said first independent feature by:
receiving instructions identifying said first feature, wherein the instructions further comprise an identification that the identified first feature is to be executed,
loading, from the data carousel, the feature data related to said first feature, into memory of said receiver,
executing said identified feature.

9. A receiver (105, 107, 109, 111, 206) adapted for receiving broadcasted signal from a broadcaster (101, 200), where the receiver is adapted for handling the execution of a first independent feature, where at least a part of the feature data needed to execute said first independent feature is comprised in said broadcaster signal as data relating to a first Xlet, wherein said data relating to said first Xlet further comprise feature data needed to execute at least a second independent feature, and wherein said feature data are broadcasted as data carousels, the receiver comprising:
means (401) for receiving instructions identifying said first feature, wherein the instructions further comprise an identification that the identified first feature is to be executed,
means (401) for loading, from the data carousel, the feature data related to said first feature, into memory of said receiver,
means (401) for executing said identified feature.

10. (canceled)

11. (canceled)
